(19) United States
(12) Patent Application Publication
(10) Pub. No.: US 2007/0281122 A1
(43) Pub. Date: Dec. 6, 2007

(54) METHOD AND APPARATUS FOR DISSIPATING ELECTRIC ENERGY IN A COMPOSITE STRUCTURE

(76) Inventors: Steven Donald Blanchard, Issaquah, WA (US); Michelle Ly, Kent, WA (US)

Correspondence Address: DUKE W. YEE, YEE & ASSOCIATES, P.C., P.O. BOX 802333, DALLAS, TX, 75380, US

(21) Appl. No.: 11/840,643

(22) Filed: Aug. 17, 2007

Related U.S. Application Data
(63) Continuation-in-part of application No. 11/163,872, filed on Nov. 2, 2005.

(51) Int. Cl. B29C 73/00

(52) U.S. Cl. 428/63; 156/94

(57) ABSTRACT

Method and apparatus for providing an electrical energy dissipation path from an area of a composite structure. A bonding site may be prepared on the composite structure that surrounds the area, and an adhesive may be applied to the prepared bonding site. An electrical energy dissipation patch may be placed on the adhesive, a caul plate may be placed over the electrical energy dissipation patch, and a heat pack may be placed over the caul plate. A compaction force may be applied to the heat pack for affixing the electrical energy dissipation patch to the bonding site. The electrical energy dissipation patch may include inner and outer electrically non-conductive layers and an electrically conductive central layer, the electrically conductive central layer including an extended portion that is electrically connected to the composite structure when the electrical energy dissipation patch is affixed to the composite structure.

### CROSS-REFERENCE TO RELATED APPLICATION

This application is a Continuation-In-Part of copending U.S. patent application Ser. No. 11/163,872 filed on Nov. 22, 2005 and entitled FAST LINE MAINTENANCE REPAIR METHOD AND SYSTEM FOR COMPOSITE STRUCTURES.

### BACKGROUND INFORMATION

1. Field

The disclosure relates generally to a method and apparatus for dissipating electrical energy in a composite structure and, more particularly, to a method and apparatus for providing an electrical energy dissipation path from an area of a composite structure, such as a composite structure of an aircraft.

2. Background

The use of structures comprised of composite materials has grown in popularity, particularly in such applications as aircraft, where benefits include increased strength and rigidity, reduced weight and reduced parts count. When damaged, however, composite structures often require extensive repair work which may ground an aircraft, thereby adding significantly to the support costs of the aircraft. Maintenance procedures frequently require that the damaged component be removed and replaced before the aircraft can resume flying.

Short commercial domestic flights may have only 30-60 minutes of time at a gate between scheduled flights, while longer and international flights may have 60-90 minutes. The Commercial Airline Composite Repair Committee (CACRC), an international consortium of airlines, OEMs and suppliers has reported, however, that the average composite repair permitted in the Structural Repair Manuals (SRMs) takes approximately 15 hours to complete. In most cases, accordingly, flight cancellations must result when a composite structure repair is performed on an aircraft at the flight line. Removing an aircraft from revenue service in order to repair a damaged composite structure not only requires the operator of the aircraft to adjust its flight schedule in order to make the necessary repairs, but may also result in passenger dissatisfaction.

Recognizing the problems inherent in repairing composite structures, commonly assigned, copending U.S. patent application Ser. No. 11/163,872 filed on Nov. 22, 2005 and entitled FAST LINE MAINTENANCE REPAIR METHOD AND SYSTEM FOR COMPOSITE STRUCTURES, of which the present application is a Continuation-In-Part, describes a method and system for repairing a damaged composite structure quickly by persons having minimal skill using minimal tools and equipment.

Although the repair method and system described in U.S. patent application Ser. No. 11/163,872 is effective in repairing a damaged area of a composite structure; the damaged area may have become electrically isolated from the surrounding structure of the aircraft as a result of the damage, and the repair may not provide a path for dissipating electrical energy from the repaired area. Particularly, when the composite structure is on an aircraft, the repaired area may be electrically isolated from the lightning strike protection system of the aircraft such that there may be no suitable path for dissipating electrical current if the repaired area is struck by lightning. Also, if the repaired area is electrically isolated from the surrounding structure, static electricity may build up in the repaired area; and when the electrical potential becomes great enough, a spark will jump. When this spark occurs on an aircraft, it may cause undesirable “noise” in the communications radio or other electrical systems of the aircraft.

There is, accordingly, a need for a method and apparatus for providing an electrical energy dissipation path from an area of a composite structure, such as a composite structure of an aircraft, for dissipating electrical energy from the area such as electrical current caused by a lightning strike or electrical potential caused by a build up of static electricity.

### SUMMARY

An embodiment of the disclosure provides a method for providing an electrical energy dissipation path from an area of a composite structure. A bonding site may be prepared on the composite structure that surrounds the area of the composite structure, and an adhesive may be applied to at least a portion of the prepared bonding site. An electrical energy dissipation patch may be placed on the adhesive, a caul plate may be placed over the electrical energy dissipation patch, and a heat pack may be placed over the caul plate. A compaction force may be applied to the heat pack for affixing the electrical energy dissipation patch to the bonding site. The electrical energy dissipation patch includes inner and outer electrically non-conductive layers and an electrically conductive central layer between the inner and outer electrically non-conductive layers. The electrically conductive central layer may include an extended portion that is electrically connected to the composite structure when the electrical energy dissipation patch is affixed to the composite structure for providing a path for dissipating electrical energy from the area.

A further embodiment of the disclosure provides an electrical energy dissipation patch for providing an electrical energy dissipation path from an area of a composite structure. The electrical energy dissipation patch may include an electrically non-conductive inner layer, an electrically non-conductive outer layer, and an electrically conductive central layer between the electrically non-conductive inner and outer layers. The electrically conductive central layer may include an extended portion that extends beyond an outer edge of the electrically non-conductive inner layer for being electrically connected to the composite structure when the electrical energy dissipation patch is affixed to the area of the composite structure.

A further embodiment of the disclosure provides a kit for providing an electrical energy dissipation path from an area of a composite structure. The kit may include an electrical energy dissipation patch. The electrical energy dissipation patch may include inner and outer electrically non-conductive layers and an electrically conductive central layer between the inner and outer electrically non-conductive layers. The electrically conductive central layer may include an extended portion that is electrically connected to the composite structure when the electrical energy dissipation patch is affixed to the composite structure for providing a path for dissipating electrical energy from the area. The kit may further include an adhesive for affixing the electrical energy dissipation patch to the composite structure, and a chemical heat pack for providing heat during curing of the adhesive.

A further embodiment of the disclosure provides a method for providing an electrical energy dissipation path to a composite structure having an electrically conductive fiber or mesh. An electrical energy dissipation patch that includes electrically non-conductive inner and outer layers and an electrically conductive central layer having an extended portion may be applied to the composite structure, such that the central layer is electrically connected to the electrically conductive fiber, mesh or expanded metal of the composite structure.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the embodiments are set forth in the appended claims. The embodiments themselves, however, as well as a preferred mode of use, further objectives and advantages thereof, will best be understood by reference to the following detailed description of advantageous embodiments when read in conjunction with the accompanying drawings, wherein:

FIG. 1 is an illustration of an aircraft in which advantageous embodiments of the disclosure may be implemented;

FIG. 2 is an illustration, greatly enlarged, of a side view of an electrical energy dissipation patch in accordance with an advantageous embodiment of the disclosure;

FIG. 3 is an illustration of a bottom view of the electrical energy dissipation patch of FIG. 2;

FIG. 4 is an illustration of an exploded side view of a system for providing an electrical energy dissipation path from an area of a composite structure in accordance with an advantageous embodiment of the disclosure;

FIG. 5 is an illustration of the electrical energy dissipation patch of FIGS. 2 and 3 affixed to a composite structure in accordance with an advantageous embodiment of the disclosure; and

FIG. 6 is a flowchart that illustrates a method for providing an electrical energy dissipation path from an area of a composite structure in accordance with an advantageous embodiment of the disclosure.

### DETAILED DESCRIPTION

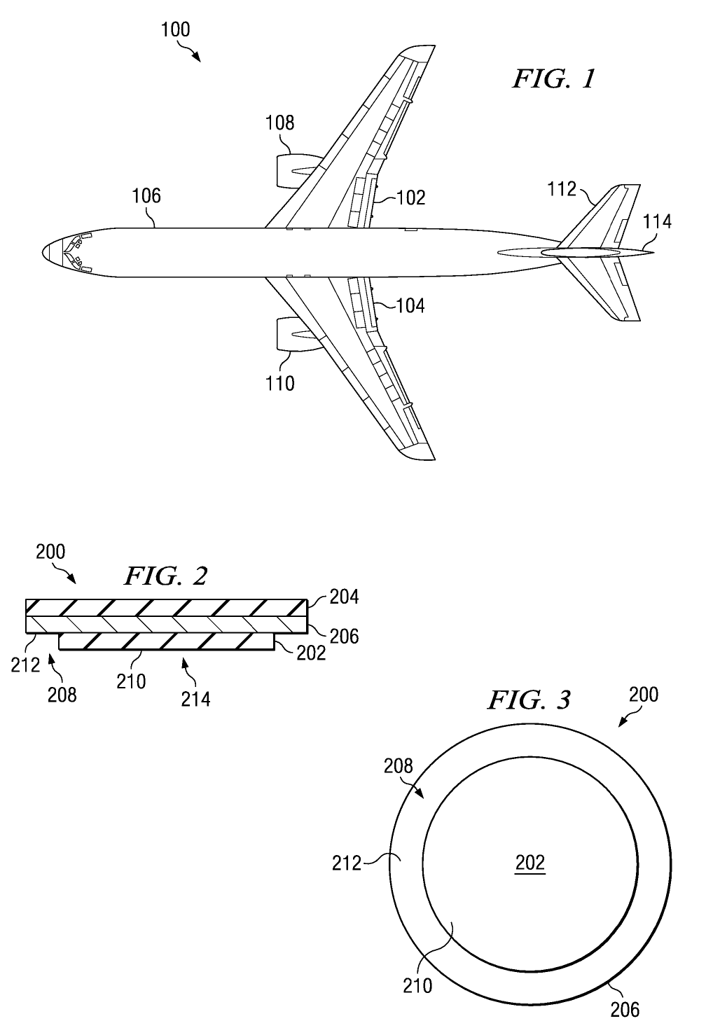

With reference now to the figures, and, in particular, with reference to FIG. 1, an illustration of an aircraft is depicted in which advantageous embodiments of the disclosure may be implemented. More particularly, aircraft 100 includes examples of composite structures to which an electrical energy dissipation patch may be affixed to provide an electrical energy dissipation path from an area of the structures in accordance with advantageous embodiments of the disclosure.

In this illustrative example, aircraft 100 has wings 102 and 104 attached to body 106. Aircraft 100 includes wing mounted engines 108 and 110. Further, aircraft 100 also includes horizontal and vertical stabilizers 112 and 114, respectively.

The use of structures formed of composite materials on aircraft has grown in popularity because such structures provide benefits of increased strength and rigidity, reduced weight and reduced parts count. Aircraft 100 may, for example, include composite structures forming body 106, wings 102 and 104, and horizontal and vertical stabilizers 112 and 114, as well as other structures including movable flight control surfaces and landing gear doors.

When damaged, however, composite structures often require extensive repair work which may ground an aircraft, thereby adding significantly to the support costs of the aircraft. Traditional maintenance procedures frequently require that the damaged component be removed and replaced before the aircraft can resume flying.

Commonly assigned, copending U.S. patent application Ser. No. 11/163,872 filed on Nov. 22, 2005 and entitled FAST LINE MAINTENANCE REPAIR METHOD AND SYSTEM FOR COMPOSITE STRUCTURES, of which the present application is a Continuation-In-Part, describes a method and system for repairing a damaged composite structure quickly by persons having minimal skill using minimal tools and equipment.

Although the repair method and system described in U.S. patent application Ser. No. 11/163,872 is effective in repairing a damaged area of a composite structure, the damaged area may have become electrically isolated from the surrounding structure of the aircraft as a result of the damage, and the repair may not provide a path for dissipating electrical energy from the area. Particularly when the composite structure is on an aircraft, the repaired area may remain electrically isolated from the lightning strike protection system of the aircraft such that there may be no suitable path for dissipating electrical current if the repaired area is struck by lightning. Also, if the repaired area is electrically isolated from the surrounding structure, static electricity may build up in the repaired area, and when the electrical potential becomes great enough, a spark will jump. When this spark occurs on an aircraft, it may cause undesirable “noise” in the communications radio or other electrical systems of the aircraft.

Advantageous embodiments of the disclosure provide a method and apparatus for providing an electrical energy dissipation path from an area of a composite structure, such as a composite structure of an aircraft, for dissipating electrical energy from the area, such as electrical current caused by a lightning strike or electrical potential caused by a build up of static electricity

According to an advantageous embodiment of the disclosure, an electrical energy dissipation patch is provided that may be applied to an area of a composite structure, such as a composite structure of an aircraft, to provide an electrical energy dissipation path from the area to dissipate electrical energy from the area. The area may, for example, be a damaged area of the composite structure, such as an area that has been struck by lightning, or it may be an area that includes a repair but that remains electrically isolated.

FIG. 2 is an illustration, greatly enlarged, of a side view of an electrical energy dissipation patch in accordance with an advantageous embodiment of the disclosure. The electrical energy dissipation patch is generally designated by reference number 200, and may include inner layer 202 and outer layer 204 of an electrically non-conductive material, and central layer 206 of an electrically conductive material. As shown in FIG. 2, central layer 206 is positioned between inner and outer layers 202 and 204. Inner layer 202 and outer layer 204 may comprise fiberglass layers, for example, a commercially-available fiberglass cloth impregnated with resin; and central layer 206 may comprise an electrically conductive metal foil such as, for example, an aluminum foil or a copper foil. It should be understood, however, that layers 202, 204 and 206 may also be formed of other materials and it is not intended to limit advantageous embodiments to particular materials for the layers of electrical energy dissipation patch 200.

Inner and outer fiberglass layers 202 and 204 may have a thickness of about four thousandths of an inch, and metal foil central layer 206 may have a thickness of about four to six thousandths of an inch, although it should also be understood that advantageous embodiments are not limited to an electrical energy dissipation patch having layers of any particular thickness. In this regard, however, it should be recognized that although outer layer 204 is primarily provided to protect the metal foil from the environmental effects of wind and water, it also acts as a dielectric. As a result, the thicker the outer layer 204, the more resistance there will be between a lightning bolt that may strike the outer layer and the metal foil, and the greater the resistance, the greater the amount of electrical energy that will be needed to penetrate the outer layer. As a result, the greater the thickness of the outer layer, the greater the damage that may be incurred if the patch is struck by lightning. Accordingly, it may be desirable for the outer layer to be maintained relatively thin while still providing effective protection for the metal foil.

FIG. 3 is an illustration of a bottom view of the electrical energy dissipation patch of FIG. 2. More particularly, FIG. 2 illustrates electrical energy dissipation patch 200 looking in the direction of arrow 214 in FIG. 2. As shown, electrical energy dissipation patch 200 is of circular shape, although this is intended to be exemplary only as electrical energy dissipation patch 200 may also be of other shapes, and it is not intended to limit advantageous embodiments to any particular shape. In the advantageous embodiment illustrated in FIGS. 2 and 3, inner fiberglass layer 202 may have a diameter of about six inches and outer fiberglass layer 204 and electrically conductive metal foil central layer 206 may have a diameter of about eight inches such that metal foil central layer 206 and fiberglass outer layer 204 define an annular-shaped extended portion 208 that extends outwardly beyond the edge of fiberglass inner layer 202 by about one inch around the entire circumference of the patch. It should be understood, however, that the dimensions of layers 202, 204 and 206 are intended to be exemplary only as advantageous embodiments are not limited to an electrical energy dissipation patch having any particular dimensions. As will be explained hereinafter, extended portion 208 of the electrically conductive central layer 206 is configured to be electrically connected to a composite structure for providing a path for dissipating electrical energy from an area of the composite structure when the electrical energy dissipation patch is affixed to the composite structure.

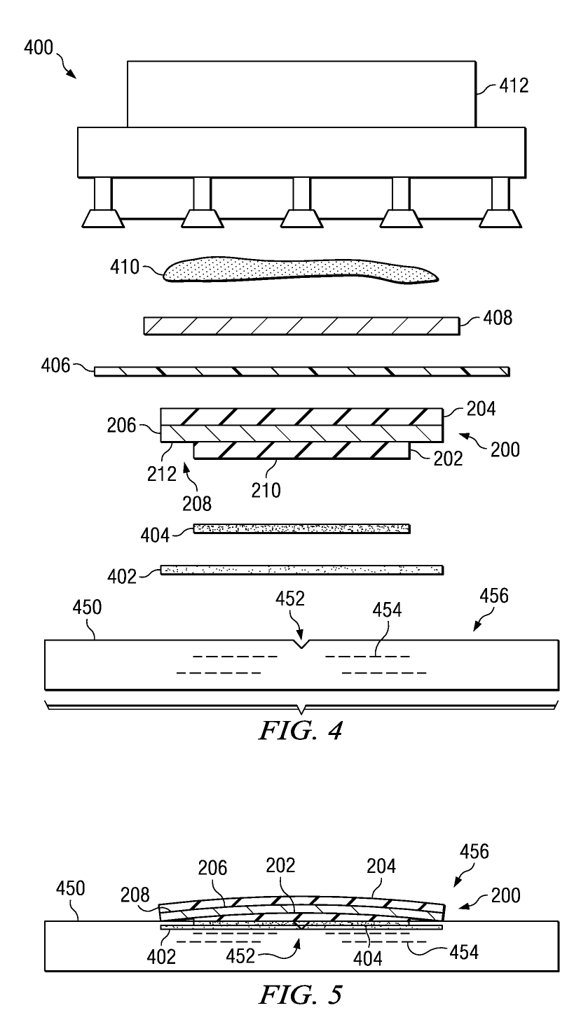

FIG. 4 is an illustration of an exploded side view of a system for providing an electrical energy dissipation path from an area of a composite structure in accordance with an advantageous embodiment of the disclosure. The system is generally designated by reference number 400, and comprises an electrical energy dissipation patch, such as electrical energy dissipation patch 200 illustrated in FIGS. 2 and 3, and various components for affixing the electrical energy dissipation patch to an area 452 of composite structure 450. Composite structure 450 may, for example, be a structure on an aircraft such as aircraft 100 illustrated in FIG. 1. As shown in FIG. 4, composite structure 450 includes a lightning strike protection system 454, for example, an electrically conductive interwoven wire fiber (IWWF) or a metal mesh lightning strike protection system, for dissipating electrical current generated by lightning striking the aircraft. According to an advantageous embodiment, when electrical energy dissipation patch 200 is affixed to an area of composite structure 450, such as area 452, an electrical connection is established between the electrically conductive central layer 206 of patch 200 and lightning strike protection system 454 within composite structure 450 to electrically connect patch 200 to the lightning strike protection system of the aircraft such that if area 452 is later struck by lightning, electrical current generated by the lightning strike will dissipate from the area through the electrically conductive central layer and into the aircraft's lightning strike protection system. In addition, any electrical potential caused by a build up of static electricity in area 452 will also be dissipated from the area in the same manner.

It should be understood that IWWF and a metal mesh are only examples of a lightning strike protection system. Other types of lightning strike protection systems may also be used including expanded metal. For example, IWWF may be used in graphite composite structures, while expanded metal may be used in fiberglass composite structures.

In the advantageous embodiment illustrated in FIG. 4, area 452 of composite structure 450 is an area that has been damaged, for example, by having been struck by lightning, and which may be electrically isolated from the surrounding composite structure as a result of the damage. In the advantageous embodiment illustrated in FIG. 4, electrical energy dissipation patch 200 is affixed directly to the damaged area to provide an electrical energy dissipation path from the damaged area to the surrounding, undamaged composite structure. In another advantageous embodiment, the damaged area may have already been repaired, for example, by a repair patch that does not provide an electrical energy dissipation path, and electrical energy dissipation patch 200 may be applied to the repair patch.

As shown in FIG. 4, system 400 includes, in addition to electrical energy dissipation patch 200, adhesive layer 402, adhesive layer 404, release film 406, caul plate 408, chemical heat pack 410 and compaction mechanism 412. Using the components illustrated in FIG. 4, electrical energy dissipation patch 200 may be affixed to composite structure 450 to provide an electrical energy dissipation path from area 452 of structure 450 in the following manner.

Initially, a bonding site 456 that includes and surrounds area 452 of composite structure 450 is prepared to receive patch 200. The preparation may include removing any material that may protrude from composite structure 450, as well as removing any paint or other covering material that may be present on the bonding site such as by sanding. The sanding should not remove the lightning strike protection system 454 from the composite structure. The prepared bonding surface may then be abraded, for example, by an appropriate abrading pad, to remove any glossy areas that may remain on bonding site 452, and the bonding site is also cleaned using, for example, pre-saturated solvent wipes.

A layer 402 of adhesive may then be applied to bonding site 456. The adhesive may be a multi-component paste adhesive that has a short working life and can cure quickly when a low temperature heat is applied. The adhesive may be applied to bonding site 456 using a notched trowel or similar tool to control the thickness of layer 402.

An adhesive layer 404 may also be applied to bonding surfaces of electrical energy dissipation patch 200. Adhesive layer 404 may be applied to both bonding surface 210 of inner fiberglass layer 202 and bonding surface 212 of protruding portion 208 of electrically conductive central layer 206 such that the central layer will be substantially coextensive with the adhesive. A notched trowel or the like may also be used to apply adhesive layer 404 to bonding surfaces 210 and 212.

After adhesive layers 402 and 404 have been applied, electrical energy dissipation patch 200 may be placed on bonding site 456 of composite structure 400. Release film 406 may then be placed over patch 200, and caul plate 408 may be placed over the release film 406. Release film 406 assists in preventing any adhesive from sticking to caul plate 408 and also provides a smooth outer surface on the caul plate. The release film may, for example, comprise a fluorinated ethylene propylene film or equivalent.

Caul plate 408 may be formed of a flexible material capable of conducting heat. For example, caul plate 408 may be a copper or aluminum caul plate having a thickness of about 0.020-0.030 inch.

Chemical heat pack 410 may then be activated and placed over caul plate 408. A variety of off-the-shelf chemical heat packs may be used. Such heat packs may have a “gel” like consistency when activated/mixed. The gelling of the heating medium of the heat pack allows the heat pack to be deployed in any orientation without adversely affecting heat transfer. This allows the heat pack to perform equally well in horizontal, vertical and inverted applications.

Heat pack 410 may, for example, comprise a sodium-acetate heat pack which provides a reliable, repeatable and uniform heat source for 30-60 minutes at about 120-130° F. For higher temperatures, a potassium permanganate heat pack may be used, for example, a heat pack that is available from Tempra Technologies Inc. of Bradenton, Fla. and that is described in U.S. Pat. No. 5,035,230. Such a heat pack provides a temperature of approximately 140-160° F. for approximately 35 minutes.

Compaction mechanism 412 may then be placed over heat pack 410 to apply a compaction force to patch 200 during curing of adhesive layers 402 and 404. The compaction mechanism 412 may comprise the manual application of pressure during the cure time (e.g., about 35 minutes), or it may comprise a compaction tool such as a vacuum bag as is illustrated in FIG. 4. A vacuum can be applied to the vacuum bag from any suitable vacuum source; or, in conjunction with a venturi device, a compressed nitrogen or air source, such as nitrogen bottles used to inflate aircraft tires can be used. The venturi creates a vacuum as compressed gas flows past the orifice in the venturi. Using a vacuum bag as a compaction mechanism provides uniformity and consistency in the adhesive bond, and may also aid in uniformly heating the adhesive layers during the curing process.

Once the time for curing adhesive layers 402 and 404 has elapsed, compaction mechanism 412, heat pack 410, caul plate 408 and release film 406 are removed. FIG. 5 is an illustration of the electrical energy dissipation patch of FIGS. 2 and 3 after the patch has been affixed to composite structure 450 in accordance with an advantageous embodiment of the disclosure. As shown, patch 200 is affixed to bonding site 456 of composite structure 450 such that it fully covers area 452 of composite structure 450. Both fiberglass inner layer 202 and the extended portion 208 of electrically conductive central layer 206 are bonded directly to composite structure 200 at bonding site 456.

As illustrated in FIG. 5, when electrical energy dissipation patch 200 is affixed to composite structure 200, extended annular portion 208 of electrically conductive central layer 206 will be affixed to and directly contact composite structure 450. As a result, electrically conductive central layer 206 will be in electrical contact with lightning strike protection system 454 within composite structure 450 to electrically connect patch 200 to the lightning strike protection system of the aircraft. Accordingly, the electrical energy dissipation patch 200 provides an electrical energy dissipation path from area 452 to the lightning strike protection system of the aircraft. As a result, patch 200 provides a path for dissipating electrical energy from area 452 such as electrical current caused by a lightning strike or electrical potential caused by a build up of static electricity. In this regard, an electrical energy dissipation patch according to advantageous embodiments provides/restores lightning strike protection of from about 10 k Amps to about 100 Amps.

An electrical energy dissipation patch according to advantageous embodiments permits an electrical energy dissipation path to be provided to a area of a composite structure, such as a composite structure of an aircraft, quickly by persons having minimal skills, using minimal tools and equipment.

An electrical energy dissipation patch according to advantageous embodiments may not provide a permanent electrical energy dissipation path for an area of a composite structure of an aircraft. The patch will, however, normally provide a reliable electrical energy dissipation path until the next regularly scheduled maintenance for the aircraft, thus making it unnecessary to remove the aircraft from regularly scheduled service.

According to an advantageous embodiment, the electrical energy dissipation patch can be incorporated in a kit that contains the patch and all items necessary or useful for affixing the patch to a composite structure. An exemplary kit may include, for example, electrical energy dissipation patch 200, and all components illustrated in FIGS. 4 and 5 for affixing the patch to a composite structure including the adhesive, the release film 406, the caul plate 408, the heat pack 410 and the compaction mechanism 412; as well as other items that may be useful in affixing the patch such as rubber gloves, goggles, sandpaper, pre-saturated solvent wipes, sanding pad, positioning tape, razor blade, notched trowel, and the like.

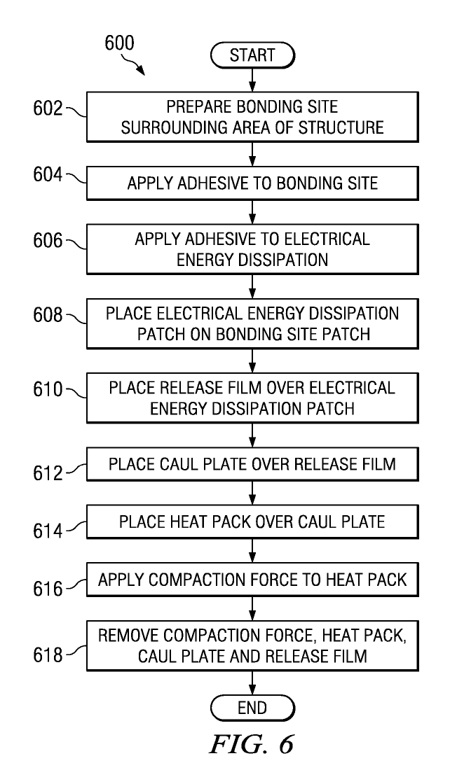

FIG. 6 is a flowchart that illustrates a method for providing an electrical energy dissipation path from an area of a composite structure in accordance with an advantageous embodiment of the disclosure. The method is generally designated by reference number 600, and begins by preparing a bonding site that encompasses and surrounds an area of a composite structure to which an electrical energy dissipation patch is to be affixed (Step 602). As indicated previously, the area may be a damaged area on the composite structure, for example, as a result of a lightning strike, or it may be an area to which a repair patch that does not provide lightning strike protection has previously been applied. An adhesive may then be applied to at least a portion of the prepared bonding site (Step 604), and the adhesive may also be applied to bonding surfaces of the electrical energy dissipation patch (Step 606). The electrical energy dissipation patch, such as patch 200 illustrated in FIGS. 2 and 3, is then placed on the bonding site of the composite structure (Step 608). A release film may then be placed over the patch (Step 610), and a caul plate may be placed over the release film (Step 612). A chemical heat pack may then be placed over the caul plate (Step 614), and a compaction force may be applied to the chemical heat pack for a period of time necessary for curing of the adhesive (Step 616). The compaction force may be applied, for example, manually or by a compaction tool such as compaction tool 412 in FIG. 4.

Following expiration of the time needed to fully cure the adhesive, the compaction force, the heat pack, the caul plate and the release film are removed (Step 618) and the method ends.

The description of the different advantageous embodiments has been presented for purposes of illustration and description, and is not intended to be exhaustive or limited to the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain features and practical applications, and to enable others of ordinary skill in the art to understand various embodiments with various modifications as are suited to the particular uses that are contemplated.

What is claimed is:

1. A method for providing an electrical energy dissipation path from an area of a composite structure, the method comprising:
preparing a bonding site on the composite structure that surrounds the area of the composite structure;
applying an adhesive to at least a portion of the prepared bonding site;
placing an electrical energy dissipation patch on the adhesive;
placing a caul plate over the electrical energy dissipation patch;
placing a heat pack over the caul plate; and
applying a compaction force to the heat pack for affixing the electrical energy dissipation patch to the bonding site, wherein the electrical energy dissipation patch comprises inner and outer electrically non-conductive layers and an electrically conductive central layer between the inner and outer electrically non-conductive layers, the electrically conductive central layer including an extended portion that is electrically connected to the composite structure when the electrical energy dissipation patch is affixed to the composite structure for providing a path for dissipating electrical energy from the area.

2. The method of claim 1, wherein the composite structure comprises a lightning a strike protection system, and wherein the extended portion of the electrically conductive central layer is electrically connected to the lightning strike protection system when the electrical energy dissipation patch is affixed to the composite structure.

3. The method of claim 2, wherein the lightning strike protection system comprises one of an electrically conductive interwoven wire fiber and a metal mesh in the composite structure.

4. The method of claim 1, and further comprising:
applying the adhesive to a bonding surface of the electrical energy dissipation patch.

5. The method of claim 4, wherein applying the adhesive to a bonding surface of the electrical energy dissipation patch comprises:
applying the adhesive to a bonding surface of the extended portion of the electrically conductive central layer.

6. The method of claim 1, wherein the inner and outer electrically non-conductive layers comprise fiberglass cloth layers, and wherein the electrically conductive central layer comprises a metal foil.

7. The method of claim 6, wherein the metal foil comprises one of an aluminum foil and a copper foil.

8. The method of claim 1, wherein the area of the composite structure comprises a repair patch that does not provide a path for dissipating electrical energy from the area.

9. The method of claim 1, wherein providing a path for dissipating electrical energy from the area, comprises providing a path for dissipating electrical current from a lightning strike to the area, and for dissipating electrical potential from a build up of static electricity in the area.

10. The method of claim 1, wherein the composite structure comprises a composite structure of an aircraft.

11. An electrical energy dissipation patch for providing an electrical energy dissipation path from an area of a composite structure, comprising:
an electrically non-conductive inner layer;
an electrically non-conductive outer layer; and
an electrically conductive central layer between the electrically non-conductive inner and outer layers; the electrically conductive central layer including an extended portion that extends beyond an outer edge of the electrically non-conductive inner layer for being electrically connected to the composite structure when the electrical energy dissipation patch is affixed to the area of the composite structure.

12. The electrical energy dissipation patch of claim 11, wherein the electrically non-conductive inner and outer layers comprise fiberglass layers, and wherein the electrically conductive central layer comprises a metal foil.

13. The electrical energy dissipation patch of claim 12, wherein the metal foil comprises one of an aluminum foil and a copper foil.

14. The electrical energy dissipation patch of claim 11, wherein the electrically non-conductive inner layer is of circular shape and has a first diameter, and wherein the electrically conductive central layer is of circular shape and has a second diameter larger than the first diameter to provide the extended portion of the electrically conductive central portion.

15. The electrical energy dissipation patch of claim 14, wherein the electrically non-conductive outer layer is of circular shape and has the second diameter for protecting the electrically conductive central layer from environmental effects.

16. The electrical energy dissipation patch of claim 15, wherein the first diameter is about six inches and the second diameter is about eight inches.

17. The electrical energy dissipation patch of claim 11, wherein the extended portion of the electrically conductive central layer is electrically connected to a lightning strike protection system in the composite structure when the electrical energy dissipation patch is affixed to the area of the composite structure for providing the path for dissipating electrical current from a lightning strike to the area, and for dissipating electrical potential from a build up of static electricity in the area.

18. The electrical energy dissipation patch of claim 11, wherein the composite structure comprises a composite structure of an aircraft.

19. A kit for providing an electrical energy dissipation path from an area of a composite structure, the kit comprising:
an electrical energy dissipation patch, the electrical energy dissipation patch comprising inner and outer electrically non-conductive layers and an electrically conductive central layer between the inner and outer electrically non-conductive layers, the electrically conductive central layer including an extended portion that is electrically connected to the composite structure when the electrical energy dissipation patch is affixed to the composite structure for providing a path for dissipating electrical energy from the area;
an adhesive for affixing the electrical energy dissipation patch to the composite structure; and
a chemical heat pack for providing heat during curing of the adhesive.

20. The kit of claim 19, wherein the inner and outer electrically non-conductive layers of the electrical energy dissipation patch comprise fiberglass cloth layers, and wherein the electrically conductive central layer comprises a metal foil.

21. A method for providing an electrical energy dissipation path to a composite structure having an electrically conductive fiber, mesh or expanded metal, the method comprising:
applying an electrical energy dissipation patch that includes electrically non-conductive inner and outer layers and an electrically conductive central layer having an extended portion to the composite structure, such that the central layer is electrically connected to the electrically conductive fiber, mesh or expanded metal of the composite structure.

22. The method of claim 21, and further comprising:
applying adhesive to the electrical energy dissipation patch such that the central layer is substantially coextensive with the adhesive.

23. The method of claim 21, wherein the composite structure comprises a composite structure of an aircraft, and wherein the electrically conductive fiber, mesh or expanded comprises a lightning strike protection system of the aircraft.

24. The method of claim 21, and further comprising:
preparing a bonding site on the composite structure that surrounds an area of the composite structure;
applying an adhesive to at least a portion of the prepared bonding site;
placing the electrical energy dissipation patch on the adhesive;
placing a caul plate over the electrical energy dissipation patch;
placing a heat pack over the caul plate; and
applying a compaction force to the heat pack for affixing the electrical energy dissipation patch to the bonding site.
